(19) United States
(12) Patent Application Publication
(10) Pub. No.: US 2013/0293053 A1
(43) Pub. Date: Nov. 7, 2013

(54) POLE PIECE AND YOKE CONNECTION FOR DC MOTOR

(71) Applicant: ADVANCED MOTORS & DRIVES, INC., East Syracuse, NY (US)

(72) Inventors: William C. Hittie, JR., Mount Prospect, IL (US); Timothy H. Sullivan, Manlius, NY (US); William Edwin Drinkwater, Greenlawn, NY (US); Michael J. Rubbo, Solon, OH (US)

(73) Assignee: Advanced Motors & Drives, Inc., East Syracuse, NY (US)

(21) Appl. No.: 13/886,485

(22) Filed: May 3, 2013

Related U.S. Application Data
(60) Provisional application No. 61/642,931, filed on May 4, 2012.

(51) Int. Cl. H02K 3/46

(52) U.S. Cl. CPC H02K 3/46
USPC 310/194

(57) ABSTRACT

A motor including a rotor and a field frame is provided. The field frame comprises a generally annular yoke, a plurality of generally arcuately spaced apart pole pieces extending from the yoke, and a winding extending at least in part about the pole pieces. The yoke includes a plurality of pole piece connection locations. Each of the pole pieces is associated with a corresponding one of the connection locations. The pole pieces and the yoke are connected at the pole piece connection locations in an interlocking manner.

### CROSS-REFERENCE TO RELATED APPLICATIONS

The present application claims priority from U.S. Provisional Application No. 61/642,931, filed May 4, 2012, the entire disclosure of which is hereby incorporated by reference herein.

### BACKGROUND OF THE INVENTION

1. Field of the Invention

The present invention relates generally to an electric motor for use in a machine. More specifically, the present invention concerns a brushless DC motor including a field frame with a yoke and interlocking pole pieces.

2. Discussion of the Prior Art

Those of ordinary skill in the art will appreciate that electric motors are used in a variety of applications, including, but not limited to, appliances and vehicles (such as cars and golf carts). In a golf cart, for instance, a direct current (DC) electric motor might be provided to drive the wheels and, in turn, to propel the cart forward or backward.

### SUMMARY

According to one aspect of the present invention, a motor including a rotor and a field frame is provided. The field frame comprises a generally annular yoke, a plurality of generally arcuately spaced apart pole pieces extending from the yoke, and a winding extending at least in part about the pole pieces. Each of the pole pieces includes a generally radially extending body having a first radial body end and a second radial body end. Each of pole pieces further includes a shoe extending generally circumferentially adjacent the first radial body end. The second radial body end includes a pair of arms defining a yoke-receiving recess therebetween. The yoke includes a plurality of pole piece connection locations, each of which includes a pair of spaced apart, generally radially-extending arm-receiving recesses and a generally radially extending yoke projection located circumferentially between the arm-receiving recesses. Each of the pole pieces is associated with a corresponding one of the connection locations, with the arms being received in respective ones of the arm-receiving recesses and the yoke projection being received in the yoke-receiving recess.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a front perspective view of an electric motor including a rotor and a field frame constructed in accordance with the principles of a preferred embodiment of the present invention;

FIG. 2 is a rear perspective view of the motor of FIG. 1;

FIG. 3 is a partially sectioned front perspective view of the motor of FIGS. 1 and 2;

FIG. 4 is a front perspective view of the brush boxes and brush insulating ring of FIGS. 1-3;

FIG. 5 is a rear perspective view of the brush boxes and brush insulating ring of FIG. 4;

FIG. 6 is a front perspective view of the field frame of FIGS. 1-3, particularly illustrating the yoke, the pole pieces, the bobbins, the coils, and the end plates of the field frame;

FIG. 7 is an exploded front perspective view of the field frame of FIG. 6;

FIG. 8 is a rear perspective view of a pole piece of the field frame of FIGS. 1-3, 6, and 7;

FIG. 9 is a front perspective view of a single lamination of the yoke of the field frame of FIGS. 1-3, 6, and 7;

FIG. 10 is a front view of the interlocking regions of a yoke lamination and a pole piece lamination of the field frame of FIGS. 1-3, 6, and 7; and

FIG. 11 is a front view of the field frame of FIGS. 1-3, 6, and 7, particularly illustrating the relationship between the pole pieces, the bobbins, and the coils.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

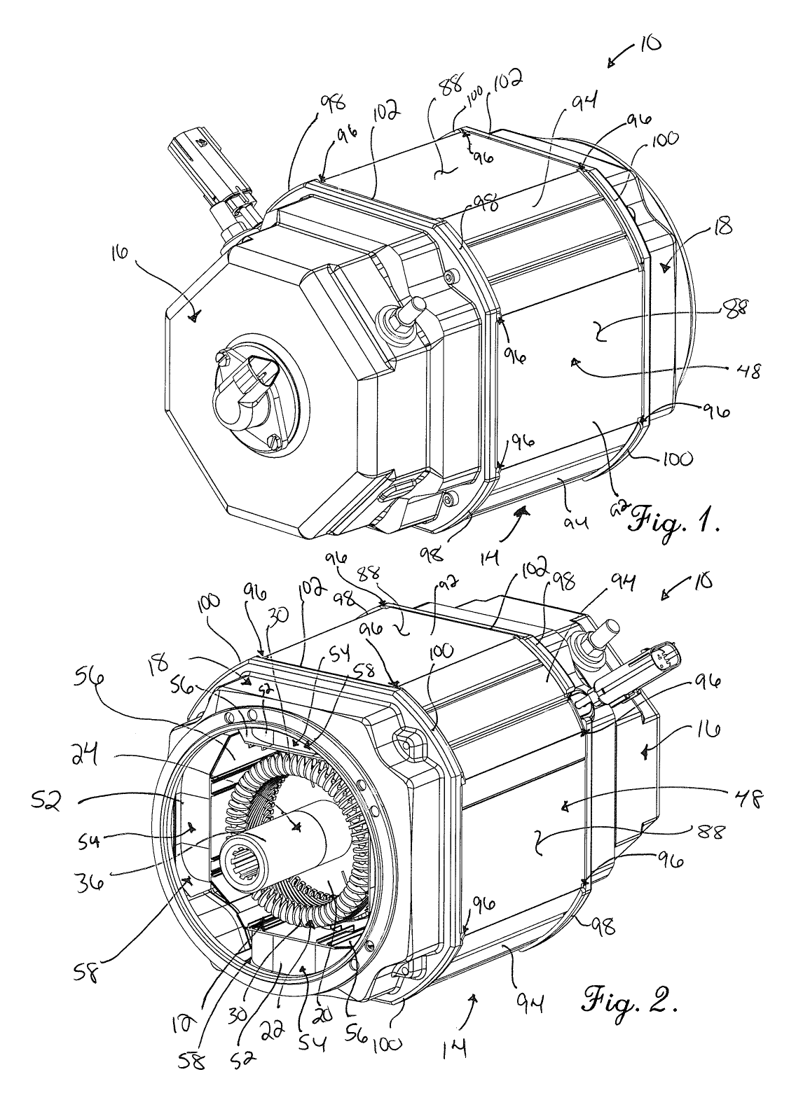

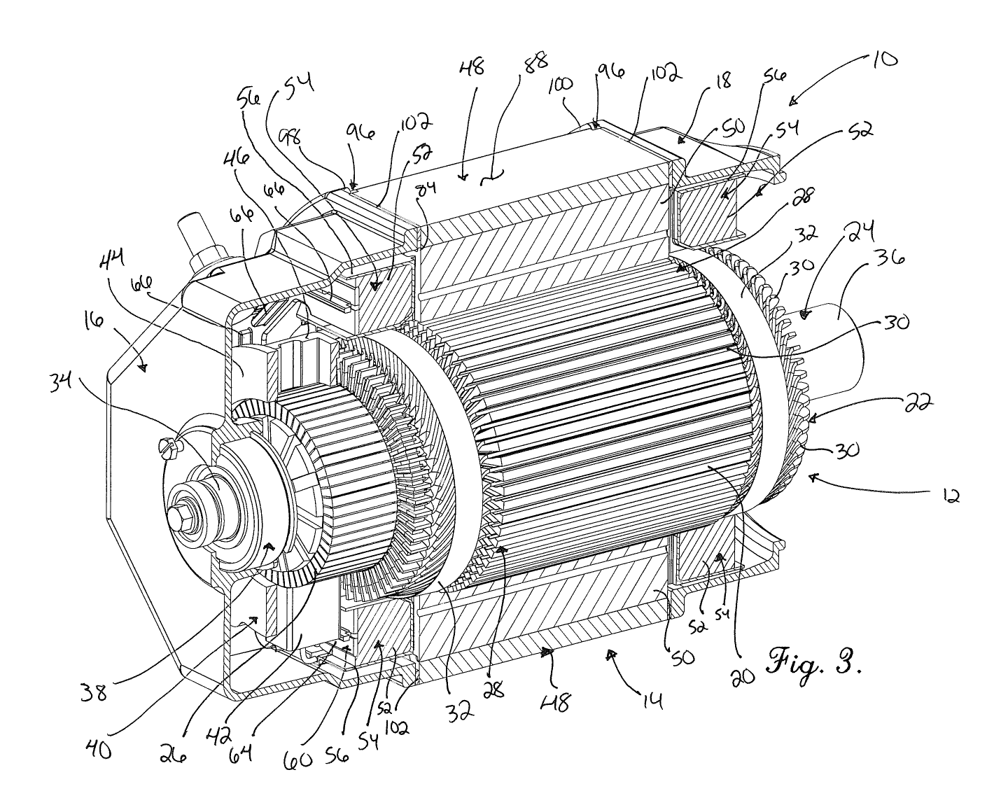

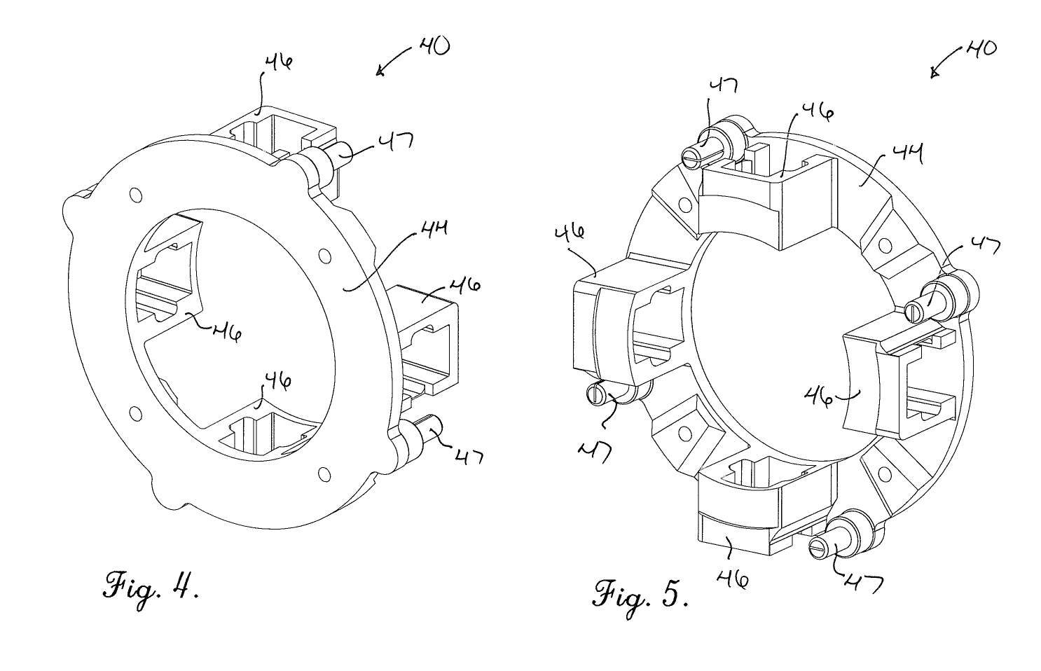

With initial reference to FIGS. 1-3, an electric motor 10 is provided. The motor 10 preferably includes a rotor or armature 12, a field frame 14, a commutator end head 16, and a machine-side end cap 18. The motor 10 is preferably a DC motor, although is permissible within some aspects of the present invention for the motor to be an alternating current (AC) motor.

The rotor or armature 12 preferably includes a core 20, armature windings 22, a rotatable shaft 24, and a commutator 26. In a preferred embodiment, the core 20 defines a plurality of slots 28, and the armature windings 22 comprise electrically conductive wires 30 interfitted in the slots 28. Binders 32 preferably encircle and retain the wires 30. The core 20 preferably comprises steel, although any one or more of a variety of ferromagnetic materials may be used. The core may be either laminated or solidly constructed without departing from the scope of the present invention.

Preferably, the shaft 24 extends through and supports the core 20 and the commutator 26, such that the shaft 24, the core 20, and the commutator 26 rotate in unison. The shaft 24 preferably includes a commutator end 34 and a machine connection end 36 configured for connection to a machine (not shown). A bearing assembly 38 preferably rotatably supports the commutator end 34 in the commutator end head 16.

In a preferred embodiment, a brush box assembly 40 is provided adjacent the commutator 26. The brush box assembly 40 preferably includes a plurality of brushes 42 associated with the commutator 26. As best illustrated in FIGS. 3, 4, and 6, the brush box assembly 40 further preferably includes a brush insulating ring 44 and pluralities of brush boxes 46 and spring pegs 47 mounted thereon. In a preferred embodiment, four brushes 42, four brush boxes 46, four springs (not shown), and four spring pegs 47 are provided, although a different number may be provided without departing from the scope of the present invention. As shown in FIG. 3, each brush 42 is mounted within a corresponding one of the brush boxes 46. A spring (not shown) corresponding to each brush 42 is mounted on the corresponding spring peg 47 and further secures the brush 42 relative to the brush box 46.

The brush insulating ring 44 is preferably molded from a thermoset material such as Glastic®, while the brush boxes 46 preferably comprise metal and are formed via stamping. It is permissible, however, for any one or more of a variety of alternative materials to be used for the brush insulating ring and/or the brush boxes without departing from the scope of the present invention.

In a preferred embodiment, the commutator end head 34 is formed from cast aluminum, although a variety of material and/or formation processes may be suitable without departing from the scope of the present invention.

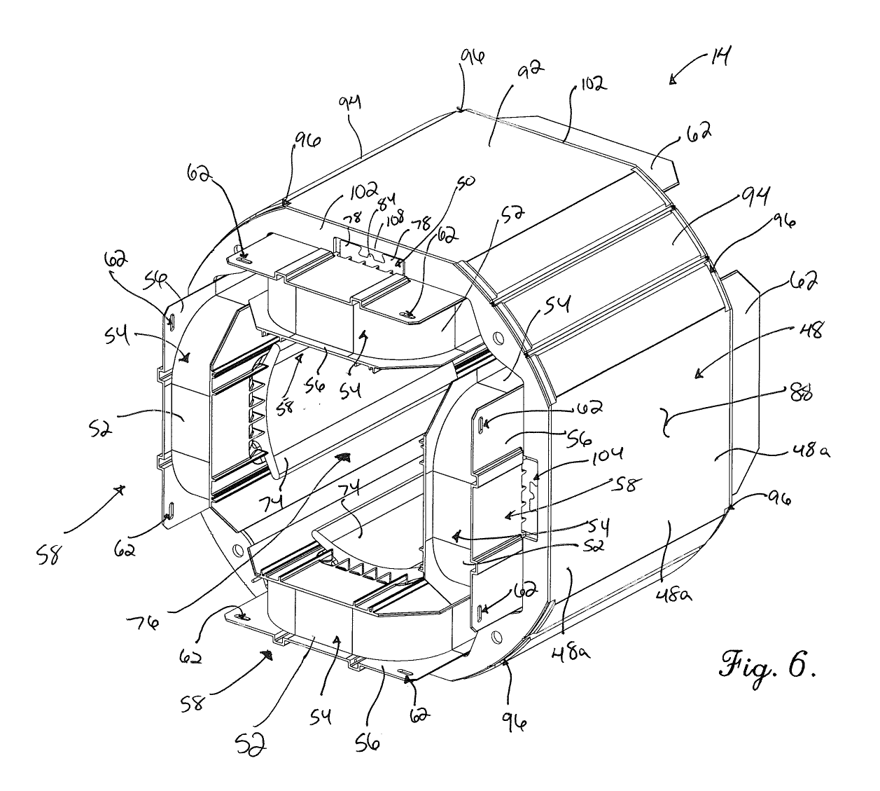

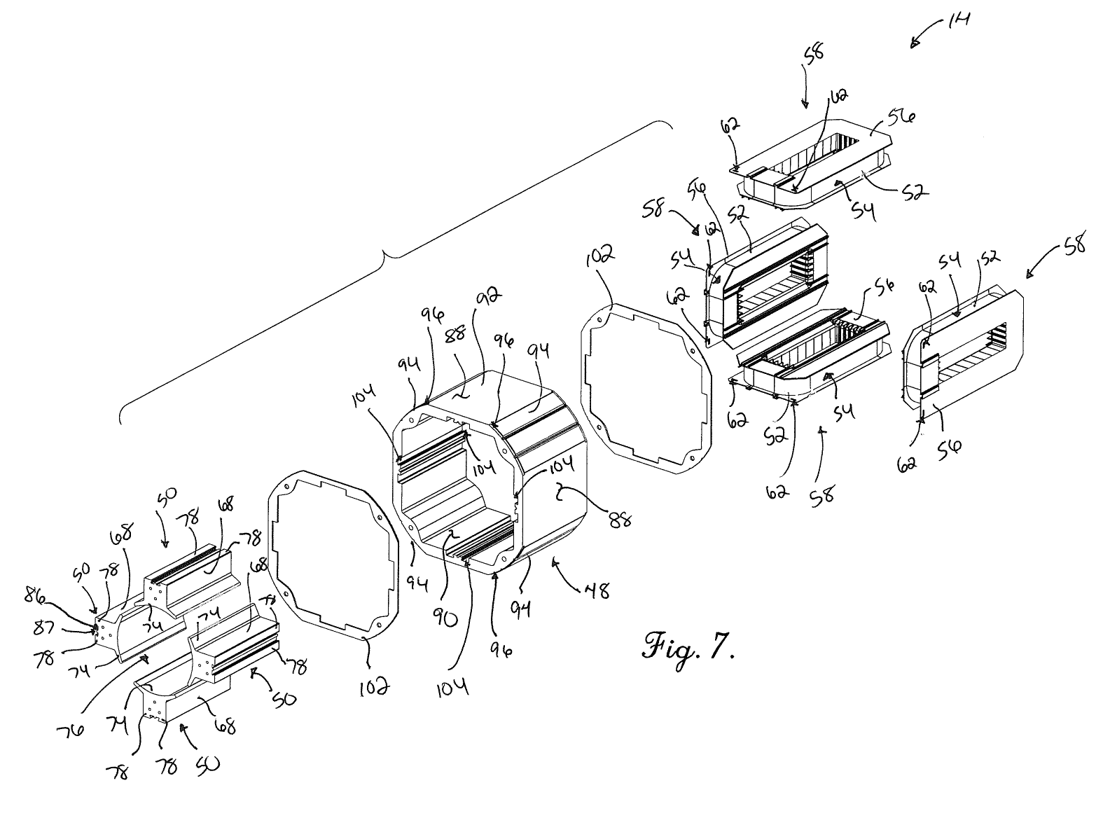

As best illustrated in FIGS. 6, 7, and 11, the field frame 14 preferably includes a generally annular yoke 48, a plurality of generally arcuately spaced apart pole pieces 50 extending from the yoke 48, and a winding 52 extending at least in part about the pole pieces 50. The motor 10 is preferably an inner rotor motor, with the field frame 14 at least substantially circumscribing the rotor 12. Certain aspects of the present invention are applicable to an outer rotor motor or a dual rotor motor, however.

As will be recognized by one skilled in the art, the motor 10 in the illustrated preferred embodiment excludes a conventional cylindrical, pipe-like outer frame. That is, the motor 10 may suitably be described as being “frameless.” As will be discussed in more detail below, the yoke 48 defines the outer surface of the motor 10 and supports the commutator end head 16 and the machine-side end cap. It is permissible within the scope of some aspects of the present invention, however, for a conventional frame to be provided.

Although no interpoles are present in the illustrated preferred embodiment, interpoles may be provided without departing from the scope of the present invention.

The winding 52 preferably includes a plurality of coils 54, each of which is wound about one of the pole pieces 50. Most preferably, four coils 54 are provided, although a different number of coils may be present without departing from the scope of the present invention.

In a preferred embodiment, at least a portion of each of the pole pieces 50 is electrically insulated. Preferably, such insulation is provided by a plurality of electrically insulative bobbins 56. Each bobbin 56 preferably carries a respective one of the coils 54 to form a coil assembly 58. Each coil assembly 58 is preferably positioned on the corresponding one the pole pieces 50. However, it is permissible for powder coating; overmolding; insulative papers, tabs, or caps; or other insulation means to be used. For instance, a thermoset compound might be molded over each pole piece in the form of a bobbin, such that an integrated pole piece/bobbin is formed.

Preferably, the winding 52 comprises an electrically conductive material. Most preferably, the winding 52 comprises aluminum. For instance, the winding 52 might suitably comprise #15 AWG size round aluminum wire. However, it is within the scope of the present invention for the winding to comprise copper and/or another electrically conductive material or materials. It is also permissible for other wire shapes to be used. For instance, the wire might present a rectangular or square cross-section.

As shown in FIG. 3, a wire tray 60 is preferably provided adjacent the bobbins 56 near the commutator 26 and the brushes 42. As shown in FIG. 6 and others, each bobbin 56 preferably includes a plurality of apertures 62. The wire tray 60 preferably includes a body 64 and plurality of generally radially extending tabs (not shown) that extend outwardly from the body 64 into the apertures 62 to secure the wire tray 60 relative to the bobbins 56. The body 64 of the wire tray 60 thus provides resistance against circumferential and radial shifting of the bobbins 56.

The wire tray 60 also preferably includes wire routing structure 66 configured to receive and direct wiring as required for the particular application.

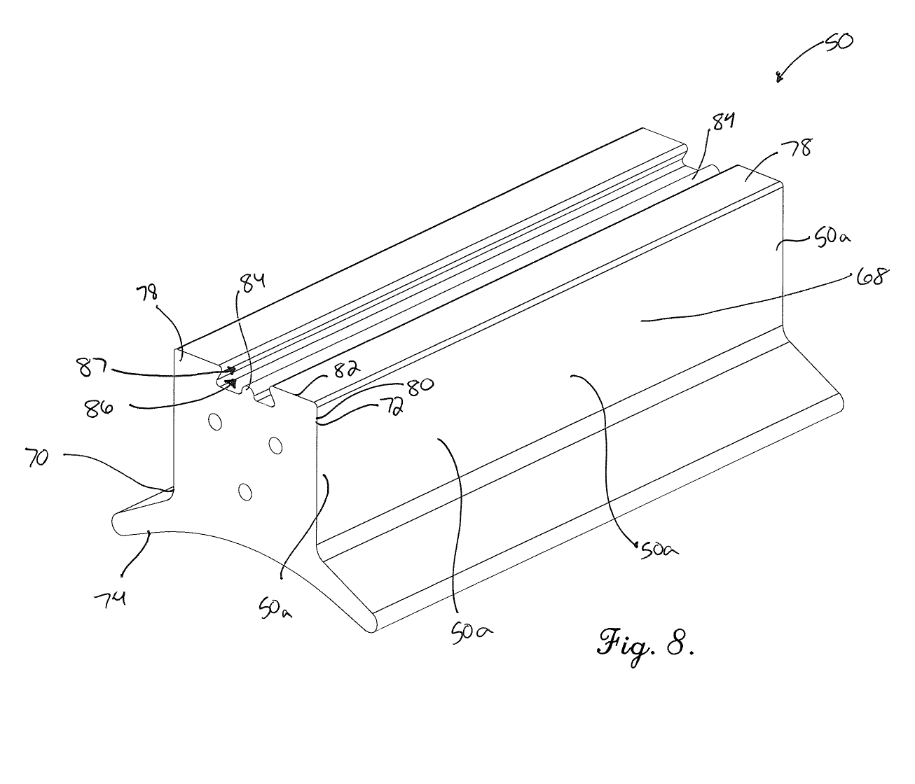

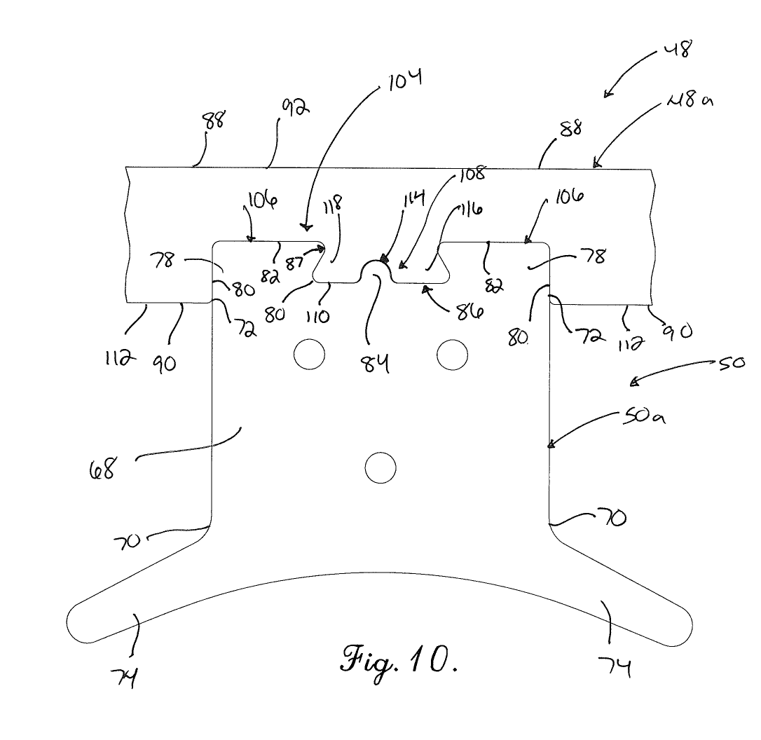

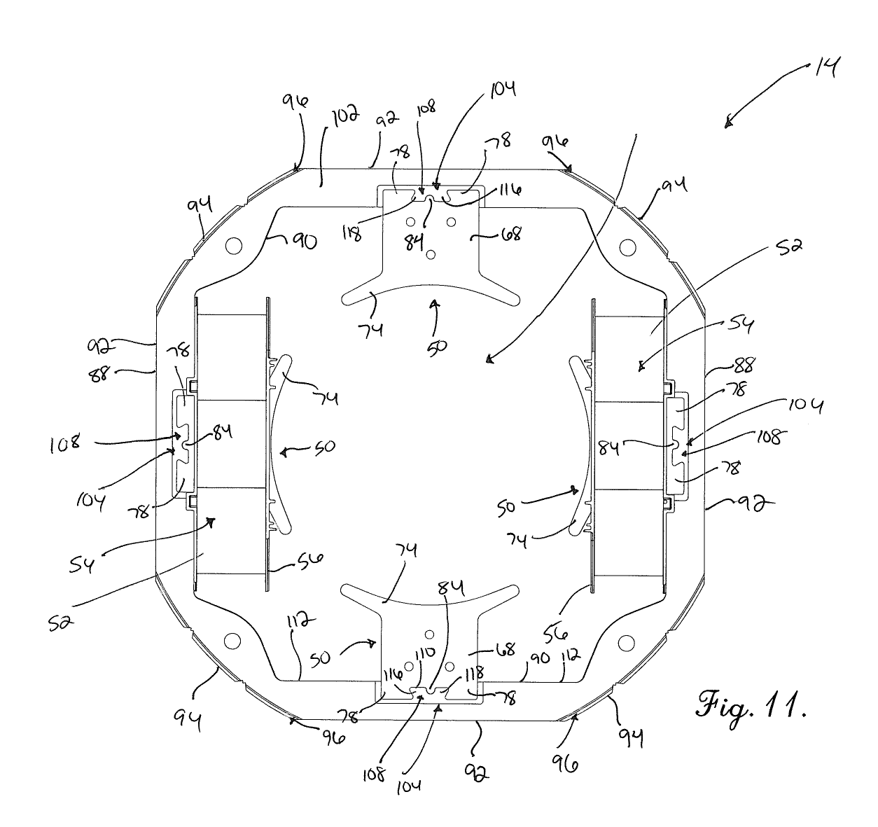

As best illustrated in FIGS. 8 and 10, each of the pole pieces 50 preferably includes a generally radially extending body 68 having an inner radial body end 70 and an outer radial body end 72. A shoe 74 preferably extends generally circumferentially adjacent the inner radial body end 70. The coils 54 are preferably wound about the bodies 68 of respective ones of the pole pieces 50, while the shoes 74 preferably extend to cooperatively define a rotor-receiving opening 76, as shown in FIG. 11.

The outer radial body end 72 of each pole piece 50 preferably includes a pair of arms 78. The arms 78 preferably extend in a generally radial direction and, for each pole piece 50, are at least substantially parallel to each other. However, it is permissible within the scope of some aspects of the present invention for the arms to extend in alternative directions and/or to be non-parallel. For instance, the arms might extend away from each other or include a substantial circumferential extension component. If an outer rotor motor is provided, the pole piece orientations may suitably be reversed, with the arms then preferably extending generally radially inwardly.

Each arm 78 preferably include opposite inner and outer radial arm ends 80 and 82, respectively. For each pole piece 50, the arms 78 are preferably flared toward each other at the outer radial ends 82. That is to say, the generally radial dimension of each arm 78 progressively increases toward the outer end 82. It is also noted that the arms 78 preferably flare toward one another for purposes which will be described. It is permissible according to some aspects of the present invention, however, for the arms to be devoid of flared regions or to include alternatively defined flared regions. The arms of a given pole piece might flare away from each other, for instance, or have flared regions defined at the inner radial arm ends.

In a preferred embodiment, each pole piece 50 includes a tang 84 spaced between the corresponding arms 78 and projecting radially outwardly from the body 68 of the corresponding pole piece 50. As will be discussed in greater detail below, each tang 84 is preferably unevenly spaced between the corresponding pair of arms 78. It is permissible, however, for the tangs 84 to be evenly spaced between the corresponding pairs of arms 78 without departing from the spirit of the present invention.

As will also be discussed in greater detail below, the arms 78 of each pole piece 50 preferably define a yoke-receiving recess 86 therebetween, with the tang 84 projecting into the yoke-receiving recess 86. Because the illustrated arms 78 flare toward one another, the yoke-receiving recess 86 presents a narrowed, radially outermost throat 87. The throat 87 is particularly beneficial in securing the pole-piece 50 to the yoke 48.

Each of the pole pieces 50 preferably comprises a plurality of pole piece laminations 50a. It is permissible according to some aspects of the present invention, however, for the pole pieces to be of solid construction.

Each pole piece 50 preferably defines an axial length. Preferably, each axial pole piece length is equal. Still further, it is preferable that the arms 78, the yoke-receiving recess 86, and the tang 84 of each pole piece 50 extend continuously along at least substantially the entire pole piece length. Discontinuous extension or truncated extension of one or more of the above may be permissible in some circumstances, however. For instance, the pole pieces might each be devoid of tangs at the axial ends.

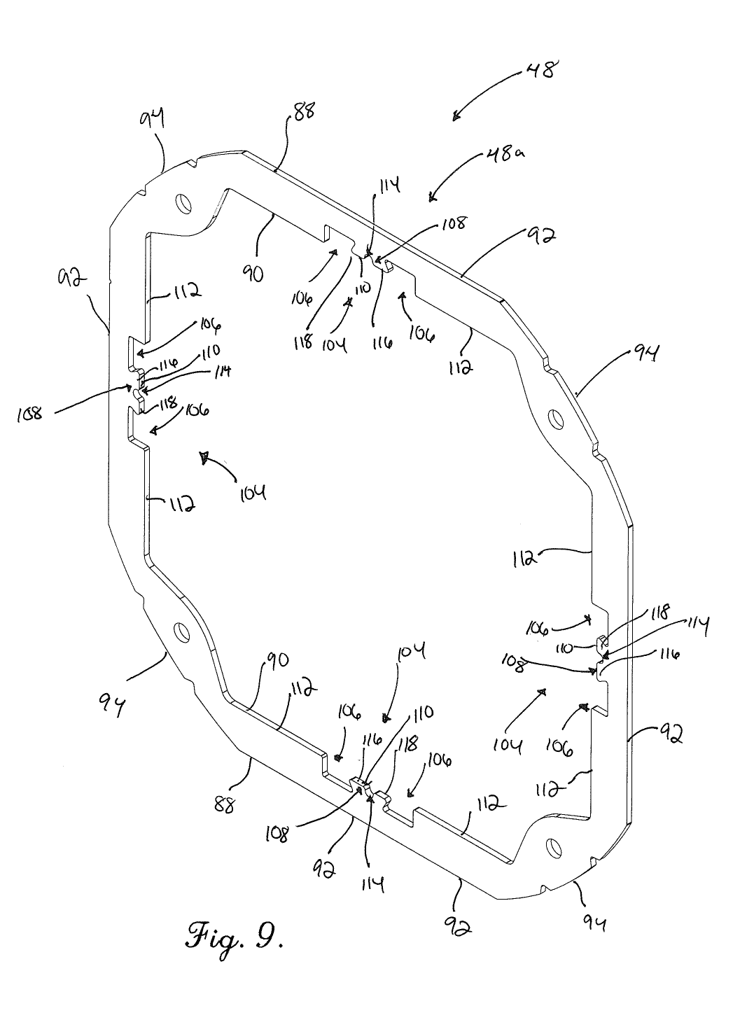

As noted previously and as best illustrated in FIGS. 6 and 9, the field frame 14 preferably includes a generally annular yoke 48. The yoke 48 preferably comprises plurality of yoke laminations 48a. It is permissible according to some aspects of the present invention, however, for the yoke to be of solid construction.

The yoke 48 preferably presents a generally circumferentially extending outer yoke surface 88 facing away from the rotor 12 and a generally circumferentially extending inner yoke surface 90 facing the rotor 12.

The outer yoke surface 88 preferably defines a generally square outer perimeter 92. Most preferably, the perimeter 92 is that of a square with rounded corners 94. It is permissible, however, for other perimeter shapes to be defined.

In a preferred embodiment and as best shown in FIG. 6, a plurality of generally circumferentially extending positioning notches 96 are formed at the rounded corners 94 at the axial ends of the yoke 48. As shown in FIGS. 1-3, the commutator end head 16 and the machine-side end cap 18 each preferably include respective pluralities of projections 98 and 100 configured to engage corresponding ones of the notches 96. Each of the projections 98 and 100 presents a generally circumferentially extending inner surface (not shown) that engages a corresponding one of the notches 96. Such engagement preferably enables controlled positioning of the commutator end head 16 and the machine-side end cap 18 relative to the yoke 48. Controlled positioning of the armature 12 relative to the yoke 48 is also thereby preferably enabled, since the armature 12 is supported in the commutator end head 16 by the bearing assembly 38. In the illustrated preferred embodiment, for instance, such engagement ensures axial alignment of the commutator end head 16, the machine-side end cap 18, and the armature 12 relative to the yoke 48.

Preferably, the yoke 48 comprises steel, although any one or more of a variety of materials may be used without departing from the scope of the present invention.

An end plate 102 is preferably positioned at each end of the yoke 48. However, it is permissible for the motor to be devoid of end plates.

In a preferred embodiment, the notches 96 extend adjacent a circumferentially extending outermost surface of each of the end plates 102, such that the end plates 102 aid in the positioning of the commutator end head 16 and the machine-side end cap 18 relative to the yoke 48. That is, the inner surfaces (not shown) of the projections 98 and 100 preferably engage the corresponding portions of the outer surfaces of the end plates 102 in addition to engaging the yoke 48 at the notches 96. However, it is permissible for the inner surfaces (not shown) of the projections to engage only the outer surfaces of the end plates 102 or only the yoke 48. In the former case, for instance, the yoke might be devoid of notches formed therein, with the circumferentially extending outer surfaces of the end plates and the radially extending faces at the axial ends of the yoke cooperatively defining the notches.

As best shown in FIGS. 9-11, the yoke 48 preferably includes a plurality of pole piece connection locations 104. Each pole piece connection location 104 preferably includes a pair of spaced apart, generally radially extending arm-receiving recesses 106 and a generally radially extending yoke projection 108 located circumferentially between the arm-receiving recesses 106.

Preferably, each of the yoke projections 108 defines a yoke projection portion 110 of the inner yoke surface 90. As best shown in FIGS. 9 and 10, the yoke projection portions 110 of the inner yoke surface 90 are preferably outwardly radially offset from a remaining portion 112 of the inner yoke surface 90. However, it is permissible for the yoke projection portions to be inwardly offset, flush, or otherwise positioned relative to the remaining portion of the inner yoke surface without departing from the scope of the present invention.

In a preferred embodiment, each of the yoke projections 108 presents a tang-receiving recess 114, such that each yoke projection 108 includes a pair of prongs 116 and 118 separated by the corresponding tang-receiving recess 114. Preferably, each tang-receiving recess 114 is unevenly spaced within the yoke projection 108, such that the prong 116 is larger than the prong 118.

The yoke 48 preferably presents an axial length, with the arm-receiving recesses 106, the yoke projections 108, and the tang-receiving recesses 114 extending continuously along at least substantially the entire yoke length. Discontinuous extension or truncated extension of one ore more of the above may be permissible in some circumstances, however. For instance, the yoke might be devoid of arm-receiving recesses adjacent each axial end.

Preferably, each of the pole pieces 50 is associated with a corresponding one of the connection locations 104. More particularly, the arms 78 are preferably received in respective ones of the arm-receiving recesses 106, the yoke projection 108 is preferably received in the yoke-receiving recess 86, and the tang 84 is preferably received in the tang-receiving recess 114. The pole pieces 50 are thus received in the yoke 48 in an interlocking manner.

In such interlocked configuration, the tang 84, the yoke projection 108, and the arms 78 are preferably subjected to a circumferential force that further restricts displacement of the pole pieces 50 relative to the yoke 48. For example, one end of the frame 14 may be placed on a stationary surface and an impact load may be exerted against the tang 84, causing a slight circumferential expansion of the tang 84 and thereby enhanced connection of the pole piece 50 and the yoke 48.

As best shown in FIG. 3, the pole piece length is preferably at least substantially equal to the yoke length, such that the axial ends of the pole piece 50 and the yoke 48 are at least substantially flush. However, it is permissible within the scope of the present invention for disparate lengths to be presented.

As noted previously, the tang-receiving recess 114 of each yoke projection 108 is offset such that the prong 116 is larger than the prong 118. Similarly, the tang 84 of each pole piece 50 is off-center relative to the corresponding arms 78. Such an asymmetrical configuration is preferable in that it allows insertion of the pole pieces 50 into the yoke 48 in only a single orientation. Such directional or orientational control is advantageous in achieving a good fit despite the presence of burs and/or other imperfections associated with the punching of the laminations of the pole pieces 50 and the yoke 48.

A preferred method for the formation and assembly of the above-described preferred embodiment of the field frame 14 is described below. First, a predetermined number of individual steel sheets are first stamped to form the pole piece laminations 50a. The pole piece laminations 50a are then stacked or assembled to form the pole pieces 50. In a similar manner, a predetermined number of individual steel sheets, which may or may not be the same as those from which the pole piece laminations 50a were stamped, are stamped to form the yoke laminations 48a. The yoke laminations 48a are then stacked or assembled to form the yoke 48.

A field coil 54 comprising aluminum windings 52 is wound onto each of a plurality of bobbins 56 to create a plurality of coil assemblies 58. Such winding is preferably done using bobbin-winding equipment, although fly winding or other techniques may be used. Each coil assembly 58 is placed on the body 68 of a corresponding pole piece 50.

Alternatively, as discussed above, a thermoset compound may be molded about each pole piece to form bobbins that are integral with the corresponding pole pieces. The integrated pole piece/bobbin can then be wound as discussed above to create a coil assembly.

Each pole piece 50 and coil assembly 58 is then fitted into a corresponding one of the pole piece connection locations 104 of the yoke 48. More particularly, each pole piece 50 is moved in an axial direction relative to the yoke 48, such that each pole piece 50 slides into the corresponding pole piece connection location 104.

The offsetting of the tangs 84 and tang-receiving recesses 114 ensures appropriate orientation between the pole pieces 50 and the yoke 48 to mitigate the effects of any manufacturing defects that may be present.

In a preferred embodiment, a tight fit is provided between the pole pieces 50 and the yoke 48 at the pole piece connection locations 104. Most preferably, the fit is an interference fit. Such a fit preferably creates generally circumferential forces that restrict displacement of the pole pieces 50 relative to the yoke 48.

Insertion of the pole pieces 50 into the pole piece connection locations 104 may require use of a punch, press, or other device due to tight tolerances (e.g., an interference fit, as discussed above). The pressure resulting from use of such devices preferably leads to a slight axial compression and corresponding circumferential expansion of at least a portion of each pole piece 50. Such circumferential expansion ensures that the arms 78, the tang 84, and the prongs 116 and 188 are subjected to generally circumferential forces that further restrict displacement of the pole pieces 50 relative to the yoke 48. As noted, additional loading may be imparted on the frame 14 to enhance the interconnection between the yoke 48 and the pole pieces 50.

Details of suitable assembly techniques of the remaining portions of the motor 10 will be readily apparent to one skilled in the art. However, it is noted that the rotor or armature 12 is positioned in the rotor-receiving opening 76 defined by the shoes 74 of the pole pieces 50. Furthermore, the commutator end head 16 and the machine-side end cap 18 are each secured directly to the yoke 48 of the field frame 14. That is, the motor 10 does not require a conventional frame or housing for assembly.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention set forth in the following claims.

What is claimed is:

1. A motor including a rotor and a field frame, said field frame comprising:
a generally annular yoke;
a plurality of generally arcuately spaced apart pole pieces extending from the yoke; and
a winding extending at least in part about the pole pieces,
each of said pole pieces including
a generally radially extending body having a first radial body end and a second radial body end, and
a shoe extending generally circumferentially adjacent the first radial body end,
said second radial body end including a pair of arms defining a yoke-receiving recess therebetween,
said yoke including a plurality of pole piece connection locations, each of which includes a pair of spaced apart, generally radially-extending arm-receiving recesses, and
a generally radially extending yoke projection located circumferentially between the arm-receiving recesses,
each of the pole pieces being associated with a corresponding one of the connection locations, with the arms being received in respective ones of the arm-receiving recesses and the yoke projection being received in the yoke-receiving recess.

2. The motor as claimed in claim 1,
each of said arms being flared.

3. The motor as claimed in claim 2,
said arms being flared toward one another.

4. The motor as claimed in claim 2,
each of said arms including opposite first and second radial arm ends,
each of said arms being flared toward one of the radial arm ends.

5. The motor as claimed in claim 4,
said second radial arm end being positioned generally radially outwardly from the first radial arm end,
each of said arms being flared toward the second radial arm end.

6. The motor as claimed in claim 1,
said arms of each pair being substantially parallel.

7. The motor as claimed in claim 1,
said field frame at least substantially circumscribing the rotor.

8. The motor as claimed in claim 7,
said yoke presenting a presenting a generally circumferentially extending yoke surface facing the rotor,
each of said yoke projections defining a yoke projection portion of the yoke surface,
said yoke projection portions of the yoke surface being generally radially offset from a remaining portion of the yoke surface.

9. The motor as claimed in claim 8,
said yoke projection portions of the yoke surface being generally outwardly radially offset from the remaining portion of the yoke surface.

10. The motor as claimed in claim 1,
each of said pole pieces further including a tang spaced between the arms and projecting into the yoke-receiving recess,
each of said yoke projections presenting a tang-receiving recess such that each yoke projection includes a pair of prongs separated by the corresponding tang-receiving recess,
each tang being received in a corresponding one of the tang-receiving recesses.

11. The motor as claimed in claim 10,
each tang being unevenly spaced between the corresponding pair of arms, such that the pair of prongs includes a larger prong and a smaller prong.

12. The motor as claimed in claim 10,
said tang, said pronged projection, and/or at least one arm of each pole piece or pole piece connection being subjected to a generally circumferential force.

13. The motor as claimed in claim 12,
said generally circumferential force being due to an interference fit between the pole piece and the yoke.

14. The motor as claimed in claim 12,
each of said tangs being subjected to an axial compressive force that creates the generally circumferential force.

15. The motor as claimed in claim 1,
said yoke having an axial yoke length,
each of said pole pieces having an axial pole piece length,
said pole piece length being at least substantially equal to the yoke length.

16. The motor as claimed in claim 1,
said yoke having an axial yoke length,
said arm-receiving recesses, said projection-receiving recesses, and said pronged projections extending continuously along at least substantially the entire yoke length.

17. The motor as claimed in claim 1,
said field frame defining a generally square outer perimeter.

18. The motor as claimed in claim 1,
said yoke comprising a plurality of yoke laminations,
said pole pieces comprising a plurality of pole piece laminations.

19. The motor as claimed in claim 1,
said winding including a plurality of coils, each of which is wound about the body of a corresponding one of the pole pieces.

20. The motor as claimed in claim 19,
at least a portion of each of said pole pieces being electrically insulated.

21. The motor as claimed in claim 20,
said field frame further comprising a plurality of electrically insulative bobbins,
each of said bobbins carrying a respective one of the coils and being positioned on the corresponding one the pole pieces.

22. The motor as claimed in claim 1,
said winding comprising aluminum wire.
